(19) United States
(12) Patent Application Publication
(10) Pub. No.: US 2015/0250188 A1
(43) Pub. Date: Sep. 10, 2015

(54) DEVICE FOR THE PRODUCTION OF BREAD OR PASTRY AND RELATED METHOD OF OPERATION

(71) Applicant: Paulo Jorge MIRANDA ISMAEL DA CRUZ, (US)

(72) Inventor: Paulo Jorge Miranda Ismael Da Cruz, Sao Domingos De Rana (PT)

(21) Appl. No.: 14/431,883

(22) PCT Filed: Sep. 30, 2013
(86) PCT No.: PCT/IB2013/059006

§ 371 Date: Mar. 27, 2015

(30) Foreign Application Priority Data
Sep. 28, 2012 (PT) 106556

(51) Int. Cl. A21B 3/13; A21D 8/02; A21C 5/00

(52) U.S. Cl. CPC A21B 3/133; A21C 5/00; A21D 8/02

(57) ABSTRACT

The present application relates to a device for the production of bread or pastry which comprises an assembly of single moulds combined with at least an assembly of individual internal wedges for the production of bread or pastry products with the arrangement of an internal space for filling. The said device allows for the leavening and later baking of bread pasta or pastry pasta with an empty internal space for filling, which can have the shape as desired by the end user.

The said device comprises at least an external mould (1) a single mould standing upright, with upper and lower openings, a lower bracket (3), horizontal braces (2), an internal wedge (4) and an upper bracket (5). The wedge is located in an upright position and is closed at its bottom base and has an opening at the top part (4), joint one another with an upper bracket (5) with openings for venting (6) and vertical tabs (7) to be fitted with the assembly of external moulds.

### TECHNICAL FIELD

The present application relates to a device for the production of bread or pastry.

### BACKGROUND

Currently, moulds used in the baking industry are employed for making the so-called “loaf of bread” as it is typically known any bread featuring a straight, rectangular shape which is to make possible being cut into slices, thus enabling an improved convenience for its consumption.

All moulds currently being used are applied for the production of bread whose proportions can be regarded as large, when compared to a small loaf for individual consumption, which due to its flat, regular shape, in most cases, or even in some cases, ultimately aims to make slicing easier, thus providing its purpose of a bread to be eaten as sliced bread. Most of the times, it is even sliced as it is provided for the final consumer.

Thus far, a sandwich-type loaf would require two overlapped slices of bread to be obtained, or else it would be required cutting it in the middle, in order to enable any kind of filling. The inconveniences of both options stand for the need of using two parts of bread and the fact that filling is not kept inside, and it can hence be spilled.

Another available option in the market stands for the so-called “Wrap” bread, which is simply a thin slice of bread that is rolled or wrapped in such a way that it allows for its filling and is therefore packed, solely with an upper opening available. The said format of arrangement is quite different from bread or patisserie which are achieved with the device disclosed herein.

There is a further available option in the market of a bread with filling, for instances, made of chocolate, wherein thee isn't actually any cut in half and/or overlapping of the two halves. However, such bread does not provide for any internal space, and solely a raw ingredient is added thereto, in the manner of a dough or tablet, with the dough still uncooked.

Document WO2007/049037A1 describes a baking device, in particular a device for the preparation of bread, which comprises an external mould able to house another mould within, aiming to allow it baking two different bread pastas. Therefore, both moulds can receive a bread pasta within totally enclosed areas. This document discloses instead a device that keeps the moulds in an open position where the internal mould is used solely to cause the pasta to be expanded within the gap comprised between those two moulds.

### SUMMARY

The present application describes a device for the production or pastry that comprises:
a lower bracket (3);
a horizontal brace (2);
at least an external mould (1));
at least an internal wedge (4);
an upper bracket (5).

According with a preferred embodiment, the device for the production of bread or pastry provides a sliding lower bracket (3).

According with another preferred embodiment, the device for the production of bread or pastry provides an external mould (1) connected with the internal wedge (4) by means of vertical flaps (7) of the upper bracket (5).

According yet with a further preferred embodiment, the device for the production of bread or pastry provides an external mould (1) with a six-sided shape.

According with a preferred embodiment, the device for the production of bread or pastry provides an external mould (1) with a base whose size is smaller than its height.

According with another preferred embodiment, the device for the production of bread or pastry provides an external mould (1) in an upright position.

According yet with a further preferred embodiment, the device for the production of bread or pastry provides an upper bracket (5) with openings for venting.

According with a preferred embodiment, the device for the production of bread or pastry provides a lower bracket (3) with two side grooves.

It is further disclosed herein a method of operation for a device which comprises the following steps:
The placement of the sliding lower bracket into the horizontal braces (3);
the introduction of the bread pasta or pastry within the external mould (1);
the placement of the internal wedges within the external moulds, by pressing the bread pasta which lies in the bottom while confirming the upper bracket fitting with the top of the external wedges through the vertical flaps (7);
The completion of the bread or pastry preparation cycle with the product leavening and baking;
Upon the completion of the cycle according with the previous step, the withdrawal of the lower bracket (5);
The disengagement of the upper bracket with the assembly of internal wedges and, finally, the bread itself or the pastry product is to be removed from the internal wedges.

### BRIEF DESCRIPTION OF FIGURES

For a better understanding of the invention, the following figures are enclosed hereto, which depict the preferred embodiments of the invention disclosed herein, whose descriptions however are not intended to limit the purpose of the present invention.

FIG. 1 exhibits a view in perspective of the assembly of the four external moulds with the related sliding lower bracket fitted in combined and the assembly of the four wedges with the upper bracket fitted in.

FIG. 2 exhibits a view in perspective of the assembly of the four single moulds and related fitting upper bracket.

FIG. 3 exhibits a view in perspective of the assembly of the four single moulds united in its base by means of two horizontal side pieces.

FIG. 4 exhibits a view in perspective of the sliding lower bracket.

### DETAILED DESCRIPTION OF AN EMBODIMENT

The present application relates to a device for the production of bread or pastry which comprises at least a single mould combined with at least an internal wedge for the production of bread or pastry with the arrangement of an internal space for filling. If there is more than one single mould, the number of internal wedges shall be equal to the total number of moulds. The said device allows for the leavening and later baking of the bread pasta or pastry with an internal space.

The operational purpose of this assembly of external mould with upper wedge, with a vertical, individual shape arrangement and including an internal pocket for filling stands for enabling the rising and growth of dough already inside the external mould assembly with upper wedge. The said external mould allows for a regular, uniform filling of the empty spaces created by the dough, thus composing the upright standing bread with an upper opening of the internal pocket for filling. The bread thus achieved may be provided with the shape as desired, preferably, it shall be provided with a six-sided shape.

This assembly of external mould with internal wedge exhibits various distinctive features, including but not limited to the following:
It is a mould for one bread, that is to say, the bread baked in it is used for a sole person, thus making its consumption and handling easier;
It is a mould where bread takes a vertical position, preferably with a six-sided shape and where its base preferably presents a size that is smaller than its height;
It is a mould that works together with an upper wedge which is to compose the internal pocket that will be used to pack the filling;
It is a mould that allows the dough to be placed without rising inside, thus allowing that growth process by means of dough yeast to take place inside.

All these features taking place concomitantly upon the assembly of the external mould with upper wedge allow the dough leavening process inside the device to occur, in a vertical, single shape with internal pocket for filling that stand out as a breakthrough as related to the current state of art. Hence, a more workable solution can be obtained for filling of bread or pastry and the achievement of a bread or pasty with internal pocket for filling.

The assembly of the external moulds comprises at least a single mould with any shape whatsoever, preferably with a six-sided shape, with a tubular, rectangular shape in an upright position, with upper and lower openings and, in the event there is more than one single mould, separated one another at regular spaces, connected in the base and in both sides by two horizontal braces, with a sliding lower bracket by means of two side braces.

The assembly of wedges connected one another comprises at least a tubular-shaped single wedge, preferably rectangular in an upright position and closed at its lower base with an opening at the upper part. In the event there is more than one single wedge, all wedges are to be connected one another with an upper bracket with openings for venting and a fitting arrangement with vertical flaps throughout the entire perimeter with the assembly of external moulds. The fitting arrangement allows the fastening of the wedges centralized with the inner part of the external wedges, thus preventing horizontal and vertical displacements.

The device may be provided with diverse levels of height according with the desired size for the bread thus obtained. Any material can be employed in the manufacturing of the device, provided that the said materials comply with the health and safety rules for food products.

The bread wall thickness is to be at least 0.5 cm, wherein the preferred thickness is to be at least of 0.75 cm, and shall have a base with at least 1 cm, whereby its preferred thickness at the base shall be 1.2 cm.

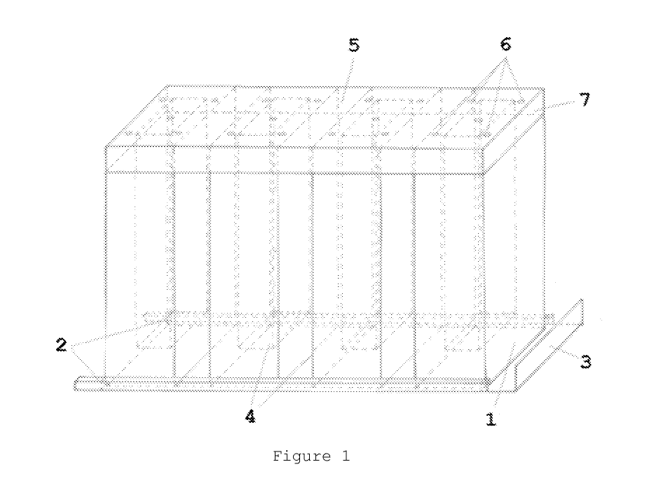

With reference to drawings, FIG. 1 generally depicts a comprehensive and enclosed assembly of devices, wherein the sliding lower bracket (3) is fitted lengthwise against the two horizontal braces (2) that connect, in both sides, parallel one another at regular spaces four external moulds (1), which in turn are fitted against the assembly of the four lower wedges (4) through vertical flaps (7) of its upper bracket (5).

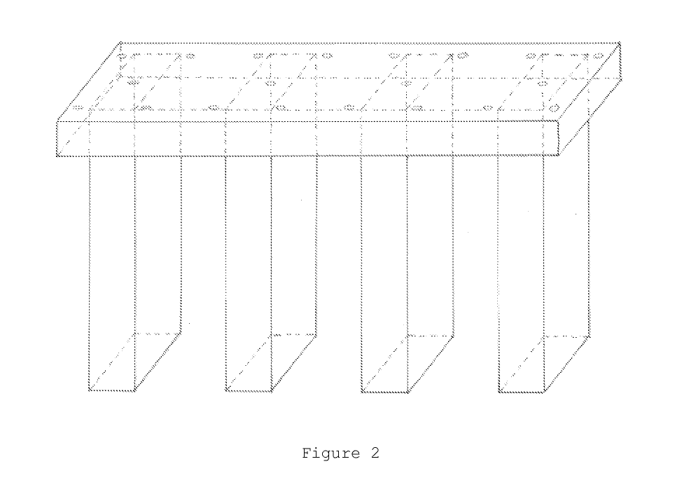

As one can see in FIG. 2, an assembly of four single wedges with a rectangular, tubular shape in an upright position is closed at its lower base and includes an opening at its upper part, whereupon they are integral with the upper bracket and are parallel one another and spaced at regular spaces, which provides openings for venting and a fitting arrangement with vertical flaps.

Its lower enclosed base allows for, after being press fitted onto the assembly of the external moulds, pressing the bread pasta or pastry, thus causing the pasta to expand during its leavening process through the available upper space, and hence moulding the internal space of the bread or pastry to allow for its filling.

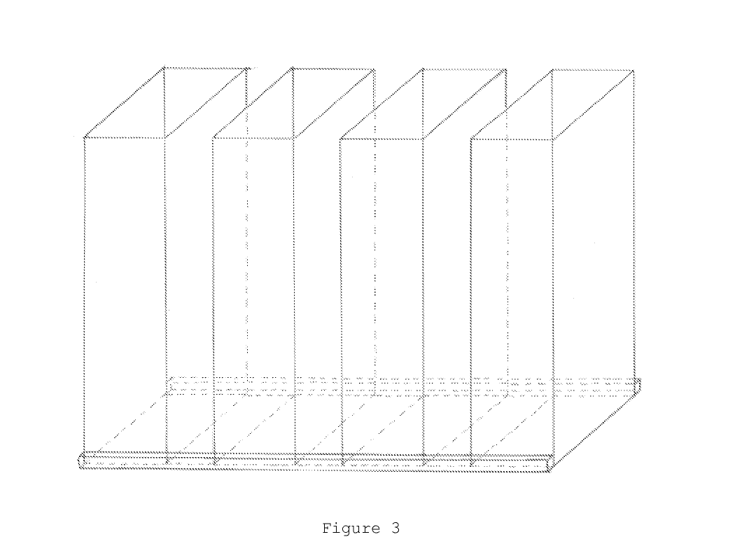

As one can see in FIG. 3, an assembly of four external, single moulds with six sides, with tubular, rectangular shape and arranged in an upright position are provided with upper, lower openings and are spaced apart parallel one another at regular spaces, being connected in their lower bases and in both sides with two horizontal braces.

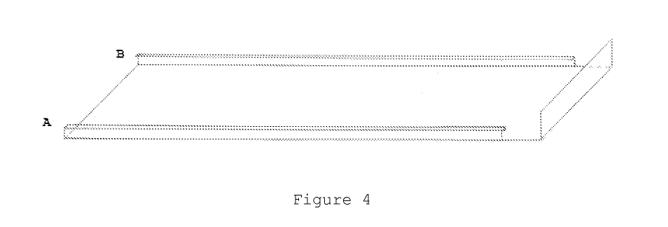

In FIGS. 3 and 4, it can be seen that the lower bracket (3) is provided with two side grooves A and B which allow it to fit and to slide through the two side braces (2), as well as a fold to make it easy for its engagement and disengagement. The said lower bracket enables closing the external moulds space at its base, so to receive the bread pasta or pastry pasta, while allowing, due to its sliding feature, its opening to make it easy the withdrawal of the product as it is baked. The bread dough is inserted through the upper opening of the external moulds and it is limited in its lower part by the sliding lower bracket that is fitted in.

With reference once again to drawing in FIG. 1, the bread product or the pastry product upon being baked, is removed from the moulds, by disengaging the lower bracket, the assembly of the internal wedges and, to end, the bread product or the pastry product itself is removed from the internal wedges.

The method for achieving the bread product and/or the pastry product shall comprise the following steps:
The placement of the sliding lower bracket (3) into the horizontal braces (2);
the introduction of the bread pasta or pastry pasta within the external mould (1);
the placement of the internal wedges within the external moulds, by pressing the bread pasta which lies in the bottom while confirming the upper bracket fitting with the top of the external wedges through the vertical flaps (7);
The completion of the bread or pastry preparation cycle with the product leavening and baking;
Upon the completion of the cycle according with the previous step, the withdrawal of the lower bracket (3);
The disengagement of the upper bracket with the assembly of internal wedges and, finally, the bread product or the pastry product itself is to be removed from the internal wedges.

Additional preferred embodiments according with the invention are also emphasized by the following Claims.

1. A device for the production of bread or pastry comprising:
a lower bracket;
a horizontal brace;
at least an external mould;
at least a tubular-shaped internal wedge;
an upper bracket;
a fitting arrangement between the wedge and the external mould through vertical flaps in the upper bracket.

2. A device for the production of bread or pastry according to claim 1, wherein the lower bracket is sliding.

3. A device for the production of bread or pastry according with to claim 1, wherein the external mould is provided with a six-sided shape.

4. A device for the production of bread or pastry according to claim 1, wherein the external mould is provided with a base whose size is smaller than its height.

5. A device for the production of bread or pastry according to claim 1, wherein the external mould stands in an upright position.

6. A device for the production of bread or pastry according to claim 1, wherein the upper bracket is provided with vent openings.

7. A device for the production of bread or pastry according to claim 1, wherein the lower bracket is provided with two side grooves.

8. The bread as obtained by means of the device described in claim 1.

9. Method of operation of the device described in claim 1, comprising the following steps:
The placement of the sliding lower bracket onto the horizontal braces;
the introduction of the bread pasta or pastry pasta within the external mould;
the placement of the internal wedges within the external moulds, by pressing the bread pasta which lies in the bottom while confirming the upper bracket fitting with the top of the external wedges through the vertical flaps;
The completion of the bread or pastry preparation cycle with the product leavening and baking;
Upon the completion of the cycle according with the previous step, the withdrawal of the lower bracket;
The disengagement of the upper bracket with the assembly of internal wedges and, finally, the bread itself or the pastry product removal from the internal wedges.

10. The use of the device as described in claim 1 for the achievement of a bread or pastry product with an empty space inside.
